(19) United States
(12) Patent Application Publication
(10) Pub. No.: US 2019/0153144 A1
(43) Pub. Date: May 23, 2019

(54) STABILISER FOR POLYOLEFIN-IN-POLYETHER POLYOL DISPERSIONS

(71) Applicant: BASF SE, Ludwigshafen am Rhein (DE)

(72) Inventors: Christian KOENIG, Ludwigshafen (DE); Frank THIELBEER, Lemfoerde (DE); Chuan Long FU, Shanghai (CN)

(73) Assignee: BASF SE, Ludwigshafen am Rhein (DE)

(21) Appl. No.: 16/320,676

(22) PCT Filed: Jul. 21, 2017
(86) PCT No.: PCT/EP2017/068442

§ 371 Date: Jan. 25, 2019

(30) Foreign Application Priority Data
Jul. 27, 2016 (CN) PCT/CN2016/091897

(51) Int. Cl. C08G 18/08; C08F 283/06; C08G 18/72; C08J 9/04; C08J 9/00

(52) U.S. Cl. CPC C08G 18/0876; C08F 283/065; C08G 2101/00; C08J 9/04; C08J 9/0061; C08G 18/72

(57) ABSTRACT

Stabiliser, comprising the reaction product of at least one macromer with at least one C₄₋₃₀-alkyl(meth)acrylate in at least one polyether polyol 1 in the presence of at least one free radical polymerisation catalyst and optionally at least one chain transfer agent, the at least one macromer being at least one molecule which comprises in its structure one or more polymerisable double bonds, able to copolymerise with C₄₋₃₀-alkyl(meth)acrylates and which furthermore comprises in its structure one or more hydroxyl-terminated polyether chains.

The invention relates to a stabiliser for polyolefin-in-polyether polyol dispersions, a process for preparing this stabiliser, its use, the dispersion, its preparation and use for preparing polyurethanes.

EP-A 1 942 122 relates to the dispersion of a preformed polymer in a polyol. A preferred stabiliser for use in PE polymer polyols is a reaction product of a maleic anhydride functionalised PE wax and a monoamino polyol, wherein imide linkages form between the reactants. One example of such a preferred stabiliser is the reaction of CERAMER® 5005 wax with JEFFAMINE® polyamine XTJ-507.

In fact, the stabiliser is an imide reaction product of a maleic anhydride functionalised polyethylene wax and a monoamine polyol.

The disadvantage of using this stabiliser is the necessity to functionalise the polyethylene with ethyl acrylate or vinyl acetate.

EP-A 0 957 130 relates to a process for preparing polyisocyanate-polyaddition products. A polyethylene powder is added to a polyether polyol formulation and not prepared separately in a polyether polyol.

U.S. Pat. No. 9,163,099 relates to polybutadiene-modified polymer polyols, foams prepared from polybutadiene-modified polymer polyols, and processes for the production thereof. A preformed stabiliser is employed which is an intermediate obtained by reacting a macromer containing reactive unsaturation with monomers like acrylonitrile, styrene, methyl methacrylate, optionally in a diluent or solvent, which can be a polyether polyol. It is preferred that polybutadiene polyols are not present in the polymer polyols. According to the examples, a propylene oxide adduct of sorbitol containing a 16% ethylene oxide cap and/or of glycerine containing an ethylene oxide cap is reacted with TMI and MDI.

Polybutadiene is employed in polymer polyols to reduce VOC emissions and improve the flame retardancy of the PU foam. The polybutadiene takes part in the radical polymerization process.

WO 2015/165878 relates to a stabiliser for polymer polyol production processes. The stabiliser is based on a macromer which is a product obtained by reaction of a three-functional polyether polyol or a six-functional polyol with 1,1-dimethyl meta isopropenyl benzyl isocyanate (TMI). The stabiliser is used for stabilizing styrene-acrylonitrile copolymer dispersions.

The object underlying the present invention is to provide a stabiliser for stabilizing polyolefin-in-polyether polyol dispersions, which lead to a long-time stability of the dispersions with finely divided polyolefin particles.

A polyolefin is any of a class of polymers produced from a simple olefin (also called an alkene with the general formula CₙH₂ₙ) as a monomer. For example, polyethylene is the polyolefin produced by polymerizing the olefin ethylene. Polypropylene is another common polyolefin which is made from the olefin propylene. Polyisobutylene is another common polyolefin which is made from the olefin isobutylen. Polybutadiene is another common polyolefin which is made from the olefin butadiene.

This invention describes, inter alia, the synthesis of a stabiliser obtained by free radical polymerization of a macromer which is used for a free radical polymerization. This product is used in a melt emulsification process in order to obtain polymer polyol products which contain polyolefins as a dispersed phase.

One aspect of this invention is to synthesise stabilisers that effectively stabilise dispersions of polyolefins in a polyether phase. It could be shown that dispersions obtained by using these stabilisers obtained by this method have small particle sizes and offer an improved long-time stability.

The composition of the inventive stabilisers is important for the stabilizing effect.

In this disclosure, the term “stabiliser” refers, in a general sense, to a chemical compound.

The stabiliser is a compound that is assumed to stabilise dispersions of polyolefins in a polyether polyol phase, and thus is assumed to stabilise polymer polyol dispersions. In particular, the stabiliser is assumed to stabilise polymer polyol dispersions obtained by melt emulsification processes.

In particular, the inventive stabiliser is appropriate for the stabilization of polymer polyol dispersions produced by melt emulsification.

In this context, the term “melt emulsification” refers to a process which involves only physical mixing of the components, rather than a chemical reaction.

The term melt emulsification is defined in WO2009/155427 as follows:

Another way of dispersing the previously-formed polymer is to melt it, and then blend the molten polymer with the polyol under shear. The shearing action breaks the molten polymer into small droplets which become dispersed in the polyol phase. This process is described in U.S. Pat. No. 6,623,827. That patent describes a process wherein a previously-formed polymer is melted in an extruder, mixed with a surfactant and a polyether polyol, and subsequently mixed with more of the polyether polyol. The mixture is then cooled to solidify the particles.

The term stabiliser may be defined as a compound obtained by reacting a macromer containing reactive unsaturation with C₄₋₃₀-alkyl(meth)acrylate and optionally styrene and acrylonitrile in a polyether polyol, wherein optionally a chain transfer agent can be used. The inventive stabilisers are used for preparing polymer polyols containing preferably small particles with D50 of below 25 μm, more preferably below 10 μm, most preferably below 5 μpm, via a melt emulsification process and should be able to stabilise the polymer polyol dispersion for a prolonged period of time (prevention of phase separation).

The stabilizing effect is determined by storing samples for a prolonged time and visually inspecting them before and after the storage period of, usually, six months. When no precipitation has been formed at the bottom of the sample container (i.e. no phase separation), the sample is considered to be stable and, thus, the stabiliser works.

The inventive stabilisers are inherently different from preformed stabilisers used for standard graft processes via free radical polymerization. Requirements and challenges for the process to form and stabilise polymer polyol dispersions via radical polymerization are fundamentally different.

The object is achieved according to the present invention by a stabiliser, comprising the reaction product of at least one macromer with at least one C₄₋₃₀-alkyl(meth)acrylate, in at least one polyether polyol 1 in the presence of at least one free radical polymerisation catalyst and optionally at least one chain transfer agent, the at least one macromer being at least one molecule which comprises in its structure one or more polymerisable double bonds, able to copolymerise with C₄₋₃₀-alkyl(meth)acrylate and which furthermore comprises in its structure one or more hydroxyl-terminated polyether chains.

The object is furthermore achieved by a process for preparing the stabiliser comprising reacting the at least one macromer with at least one C₄₋₃₀-alkyl(meth)acrylate in at least one polyether polyol 1 in the presence of a free radical polymerisation catalyst and optionally at least one chain transfer agent.

A preferred chain transfer agent is a thiol like dodecane thiol, which can be employed in the usual amounts.

The object is furthermore achieved by the use of this stabiliser for the stabilization of polymer polyol dispersions produced by melt emulsification.

The invention furthermore relates to a dispersion of at least one polyolefin in at least one polyol 3, comprising at least one stabiliser as defined above.

Polyol 3 can be freely chosen. It is preferably selected from the group of polyetherols, specifically polyether polyols, polyesterols, polycarbonate polyols, polyetheramines, hydroxyl-functionalised fatty acid derivatives and alkoxylation products of the before-mentioned groups and mixtures thereof.

Polyol 3 can correspond to polyether polyol 1 and/or polyether polyol 2.

The invention furthermore relates to a process for preparing this dispersion comprising the melt emulsification of the at least one polyolefin, the at least one polyether polyol and the at least one stabiliser.

The invention furthermore relates to the use of such dispersion for preparing a polyurethane, which can be a foam or a compact material, a corresponding process and a polyurethane obtainable by the process.

Polyurethanes obtained by dispersions produced by polyols using this process have improved hydrolytic stability and reduced moisture uptake.

The stabiliser according to the present invention comprises the reaction product of at least one macromer with at least one C₄₋₃₀-alkyl(meth)acrylate in at least one polyether polyol 1.

A macromer is defined as a molecule which comprises one or more polymerisable double bonds able to polymerise with C₄₋₃₀-alkyl(meth)acrylates and which comprises one or more hydroxyl-terminated polyether chains. Typical macromers comprise polyether polyols having an unsaturated group, which are commonly manufactured by reacting a standard polyether polyol with an organic compound containing an unsaturated group and the reactive group listed above.

The at least one macromer is at least one molecule which comprises in its structure one or more polymerisable double bonds able to copolymerise with C₄₋₃₀-alkyl(meth)acrylates, which comprises in is structure one or more hydroxyl-terminated polyether chains.

The at least one macromer is preferably obtained by reacting at least one polyether polyol 2 with an organic compound containing a polymerisable double bond able to copolymerise with C₄₋₃₀-alkyl(meth)acrylates and a carboxyl, anhydride, isocyanate, epoxy or other functional group able to react with an active hydrogen-containing group.

The molar ratio of polymerisable double bonds to hydroxyl groups of the polyether polyol 2 to be reacted is preferably in the range of from 0.03 to 0.30, more preferably 0.06 to 0.23, most preferably 0.10 to 0.16, for example about 0.13.

The organic compound containing a polymerisable double bond able to copolymerise with C₄₋₃₀-alkyl(meth)acrylates and a carboxyl, anhydride, isocyanate, epoxy or other functional group able to react with an active hydrogen-containing group is preferably selected from isocyanatoethyl methylacrylate (IEM), 1,1-dimethyl meta-isopropenyl benzylisocyanate (TMI) or mixtures thereof.

In a preferred embodiment of this invention TMI is used for manufacturing the macromer.

Usually, macromers are synthesised in the presence of Lewis acid catalysts.

The suitable Lewis acid catalysts generally comprise tin-based, boron-based, aluminium-based, gallium-based, rare earth-based, zinc-based, or titanium-based compounds.

Representative tin-based compounds include: Dibutyltin diacetate, Dibutyltin, dibromide, Dibutyltin dichloride, Dibutyltin dilaurate, Dibutyltin dimethoxide, Dibutyltin oxide, Dimethyltin diacetate, Dimethyltin dibromide, Diphenyltin dichloride, Diphenyltin oxide, Methyltin trichloride, Phenyltin trichloride, Tin(IV) acetate, Tin(IV) bromide, Tin(IV) chloride, Tin(IV) iodide, Tin(II) oxide, Tin(II) acetate, Tin(II) bromide, Tin(II) chloride, Tin(II) iodide, and Tin(II) 2-ethylhexanoate (stannous octoate). Representative boron-based compounds include: Boron tribromide, Boron trichloride, Boron trifluoride, and tris(pentafluorophenyl)borane. Representative aluminium-based compounds include: Aluminium chloride and Aluminium bromide. Representative gallium-based compounds include: Gallium chloride, Gallium bromide, and Gallium(III) actylacetonate.

Representative rare earth catalysts are generally salts of Scandium, Yttrium, Lanthanum, Praseodymium, Neodymium, Erbium, Thulium, Ytterbium, Neodymium or Lutetium. Examples include: Ytterbium triflate, Ytterbium(III) actylacetonate, Erbium(III) trifluorosulfonate (erbium triflate), Erbium(III) actylacetonate, Holmium triflate, Terbium triflate, Europium triflate, Europium(III) trifluroacetate, Samarium triflate, Neodymium triflate, Neodymium(III) actylacetonate, Praseodymium triflate, Lanthanum triflate, and Dysprosium triflate. Representative zinc-based compounds include Zinc chloride and Zinc bromide. Representative titanium compounds include Titanium(IV) bromide and Titanium(IV) chloride.

A number of methods for inducing reactive unsaturation into a polyol are known in the art. The synthesis of useful macromers is described in WO2005/003200. Macromer A is a product obtained by reaction of a three-functional polyether polyol with 1,1-dimethyl meta-isopropenyl benzyl isocyanate (TMI). Macromer B is a product obtained by reaction of a six-functional polyether polyol with 1,1-dimethyl meta-isopropenyl benzyl isocyanate (TMI).

Preferably, the stabiliser is based on a two- to eight-functional, more preferably three- to six-functional polyether polyol 1.

The molecular weight of (Mₙ) of the polyether polyol 1 is preferably in the range from 5,000 to 30,000 g/mol, more preferably 10,000 to 25,000 g/mol, most preferably 15,000 to 20,000 g/mol. The more preferred molecular weight (Mₙ) is about 80,000 g/mol. The molecular weight is preferably determined by gel permeation chromatography using Polystyrene as standard and THF as eluent/solvent.

The polyether polyols 1 and 2 can be the same or different.

According to one embodiment of the invention, polyether polyols 1 and 2 are the same. According to a second, more preferred embodiment, polyether polyol 2 is a six-functional polyether polyol and polyether polyol 1 is a three-functional polyether polyol. The molecular weights can be in the above-mentioned range.

When a six-functional polyol is employed in the polyether polyol 2, the molar ratio of TMI to polyether polyol is preferably 0.2 to 1.8, more preferably 0.4 to 1.4, most preferably 0.6 to 1.0, for example about 0.8.

The polyether polyols 1, 2 and 3 employed according to the present invention are prepared by known methods, for example from one or more alkylene oxides having from 2 to 4 carbon atoms in the alkylene radical by anionic polymerization using alkali metal hydroxides or alkali metal alkoxides as catalysts with addition of at least one polyol starter molecule, or by cationic polymerization using Lewis acids, such as antimony pentachloride or boron fluoride etherate. Suitable alkylene oxides are, for example, tetrahydrofuran, 1,3-propylene, oxide, 1,2- or 2,3-butylene oxide and preferably ethylene oxide and 1,2-propylene oxide.

Furthermore multi-metal cyanide compounds, known as DMC catalysts, can also be used as catalysts. The alkylene oxides can be used individually, alternately or in succession or as a mixture. Preference is given to mixtures of 1,2-propylene oxide and ethylene oxide, with the ethylene oxide being used in amounts of from 10 to 50% as ethylene oxide and block (“EO cap”), so that the polyols formed have more than 70% primary OH end groups.

Possible starter molecules are two- to eight-functional alcohols, such as ethylene glycol, 1,2- and 1,3-propane diol, diethylene glycol, dipropylene glycol, 1,4-butane diol, glycerol or dimethylol propane, sugars, sorbitol or pentaeritritol.

The stabiliser according to the invention may also be named preformed stabiliser.

EP-A 1 675 885 gives a definition of the term preformed stabilisers:

A pre-formed stabiliser (PFS) is particularly useful for preparing a polymer polyol having a lower viscosity at a high solid content. In the pre-formed stabiliser processes, a macromer is reacted with monomers to form a co-polymer composed of macromer and monomers. These co-polymers comprising a macromer and monomers are commonly referred to as pre-formed stabilisers (PFS). Reaction conditions may be controlled such that a portion of the co-polymer precipitates from solution to form a solid. In many applications, a dispersion having a low solids content (e.g., 3 to 15 wt %) is obtained. Preferably, the reaction conditions are controlled such that the particle size is small, thereby enabling the particles to function as “seeds” in the polymer polyol reaction.

As explained above, preformed stabilisers (PFS) are in principle known in the art for processes to form a dispersion by radical polymerization. However, the requirements for stabilisers to be used in the melt emulsification process are different (even though the manufacturing of the stabilisers may be similar).

The melt emulsification process involves only physical mixing of the components, rather than a chemical reaction. In the conventional methods (radical polymerization), the PFS or macromers are added during the radical polymerization. Thus, the residence times are different, and there is no post-polymerization or further polymer chain growth in the melt emulsification process.

The macromers used for synthesizing the inventive stabiliser usually have functional groups that are assumed to interact with the polyols of the polymer polyol product to be stabilised and can react with the isocyanate during the PU reaction. This process improves the integration of graft particles in the PU network.

The inventive stabilisers usually have a viscosity in the range between 1000 to 100.000 mPas, preferably 5000 to 80.000 mPas, more preferably 8000 to 60.000 mPas at 25° C.

The viscosity of the polyols is, unless indicated otherwise, determined at 25° C. in accordance with DIN EN ISO 3219 from 1994 by means of a Rheotec RC20 rotational viscometer using the spindle CC 25 DIN (spindle diameter: 12.5 mm; internal diameter of measuring cylinder: 13.56 mm), however at a shear rate of 100/1 s (instead of 50/1 s).

The inventive stabilisers usually have an OH number of 1 to 100, preferably 1 to 50 mg KOH/g, more preferentially 10 to 40 mg KOH/g.

The hydroxyl number is determined in accordance with DIN 53240 from 2012 (DIN=“Deutsche Industrienorm”, i.e. German industry standard).

For preparing the macromers, C₄₋₃₀-alkyl(meth)acrylates are employed. The alkyl acrylates are preferred over the alkyl(meth)acrylates. Preferably are C₆₋₂₈-, more preferably C₁₀₋₂₆-, most preferably C₁₇₋₂₂-alkyl acrylates are employed. Examples are C₂₂-, C₁₈- and C₁₇-alkyl acrylates. The alkyl residue can be linear or branched and is preferably linear. Especially preferred is behenyl acrylate.

The C₄₋₃₀-alkyl(meth)acrylate can be employed together with acrylonitrile, styrene or a mixture thereof. It is also possible that the reaction product of the at least one macromer with the at least one C₄₋₃₀-alkyl(meth)acrylate is free from polymerised acrylonitrile and styrene units. Specifically, the products which are free from polymerised acrylonitrile and styrene units differ significantly from the stabilisers disclosed in WO 2015/165878. The amount of the at least one C₄₋₃₀-alkyl(meth)acrylate is preferably 5 to 50 wt %, more preferably 10 to 35 wt %, most preferably 20 to 25 wt %, for example about 22.5 wt %, based on the total amount of the stabiliser, which is 100 wt %.

If employed, the total amount of C4-30-alkyl(meth)acrylate, acrylonitrile and styrene is in the range from 5 to 90 wt %, more preferably 10 to 50 wt %, most preferably 20 to 40 wt %, based on the total amount of the stabiliser, which is 100 wt %.

The weight ratio of the reaction product of at least one macromer with at least one C4-30-alkyl(meth)acrylate to the at least one polyether polyol 1 is preferably in the range of from 20:80 to 80:20, more preferably 50:50 to 70:30, for example about 60:40.

The synthesis of the inventive stabilisers described herein is usually carried out by reacting a macromer or a mixture of macromers with C₄₋₃₀-alkyl(meth)acrylate and optionally styrene and acrylonitrile in a carrier polyol (polyether polyol 1) in the presence of a radical initiator and optionally a chain transfer agent in a free radical polymerization. This reaction is usually carried out in a semi-batch process; however a batch procedure or a continuous process is also possible. The monomers, the macromer or the macromer mixture, the carrier polyol, the initiator or the chain transfer agent can be added to the reactor before, during or after the reaction, continuously or stepwise.

Different radical initiators can be used, for example azo derivatives, such as AIBN, peroxides such as tert-amyl peroxides, hydroperoxides and percarbonates. Most preferred are azo derivatives, in particular AIBN (azoisobutyro nitrile) and/or dimethyl 2,2,-azobis(2-methylpropionate).

The inventive stabilisers may be used to stabilise polymer polyol dispersions, in particular polymer polyol dispersions produced by melt emulsification.

In a preferred embodiment, the obtained polymer polyol dispersion when using the inventive stabiliser has a solid content of 10 to 50 wt %, preferably 30 to 46 wt %, a viscosity of 1000 to 20000 mPas, preferably 3000 to 15000 mPas, more preferably 5000 to 12000 mPas at 25° C. and a shear rate of 100 to 1/s.

In order to determine the solid content, a polymer polyol sample is added into a centrifugal tube where it is diluted with solvent and fully shaken up; the mixture is centrifugally separated on a high-speed centrifuge, and the supernatant will be removed from the centrifugal tube by pouring; the whole process mentioned above will be repeated at least twice, and then the centrifugal tube filled with sample is put into a vacuum oven for drying; after it is cooled down to the room temperature, solid remained in the centrifugal tube will be weighed to calculate the solid content in the sample.

The inventive stabilisers preferably have a particle size D50 smaller than 0,5 μm, more preferentially smaller than 0,3 μm (as determined by static laser diffraction using a Mastersizer 2000 (Malvern Instruments Ltd) after dilution of the sample with isopropanol in order to obtain an optical concentration suitable for the measurement. For the dispersion of the sample a dispersing module Hydro SM was used with a stirrer speed of 2500 rpm. The calculation of the particle size distribution may be performed by the Mastersizer 2000 using Fraunhofer theory). The molecular weight of a polyol in general may be calculated by the following formula:

Mn=f×56100/OH-value, wherein Mn=number average molecular weight in g/mol, f=functionality, the number of OH groups per molecule, determined by the starter used to synthesise the macromer, OH-value=hydroxyl number of oligo-polyol in mg KOH/g.

The stabiliser according to the present invention is used for the stabilization of polymer polyol dispersions produced by melt emulsification. Specifically, polyolefins are stabilised in polyether polyols 3.

The polyolefins are preferably selected from polyethylene, polypropylene, polybutylene, poly-isobutylene, polybutadiene (which might be partially hydrogenated) and mixtures thereof and copolymers thereof or—less preferred—their copolymers with other monomers which can be copolymerised therewith.

Usually, the molecular weight (Mₙ) of the polyolefin is in the range of from 500 to 1000000, more preferably from 750 to 500000, most preferentially 1000 to 100000.

In the dispersion of the at least one polyolefin in at least one polyol 3, comprising at least one stabiliser as defined herein, polyol 3 can be the same as polyether polyol 1 and/or polyether polyol 2.

The dispersion preferably comprises 5 to 20 wt %, more preferably 7 to 15 wt %, for example about 10 wt %, of the at least one stabiliser and 10 to 60 wt %, more preferably 10 to 50 wt%, for example about 40 wt % of the at least one polyolefin, based on the total amount of the dispersion, which is 100 wt %.

The remainder of the dispersion is typically the polyol 3.

For preparing this dispersion, a melt emulsification of the at least one polyolefin, the at least one polyol 3 and the at least one stabiliser is performed.

The melt emulsification is preferably performed in an extruder at a temperature in the range of from 140 to 240° C., more preferably 155 to 220° C., most preferably 170 to 190° C., for example about 180° C. Alternatively, the melt emulsification may be performed in a kneader, at a temperature in the range from 180 to 260° C., more preferably 210 to 255° C., most preferably 230 to 250° C., for example about 240° C.

The polymer polyol dispersion stabilised by using at least one inventive stabiliser may be used for the production of polyurethanes (PU).

Usually, in the production of polyurethanes, at least one polyol is reacted with at least one polyisocyanate, optionally in the presence of at least one blowing agent and/or catalyst. A typical A-component in this PU production process consists of one or more polyols, one or more polyurethane catalysts, one or more surfactants, one or more crosslinkers, water or optionally other chemical or physical blowing agents. The B-component usually contains the isocyanates.

In another embodiment of the present invention, the polymer polyol comprising the inventive stabiliser may also be used to obtain a stable A-component in a PU production process, such that the A-component may be stored for a prolonged time without phase separation.

### EXAMPLES

In the following sections, some experimental examples are given in order to illustrate some aspects of the present invention.

### Example 1

### Preformed Stabiliser

A three litre reactor was charged with a polyol mixture of polyol Lupranol® 2095 (trifunctional polyetherol with primary OH endgroups based on glycerol with MW 5000 by BASF SE) and a six functional polyetherol modified with 3-isopropenyl-α,α-dimethylbenzene isocyanate (1 mol per mole polyetherol). The mass ratio of the polyetherols was 29:47.5. Furthermore, 22.5 wt % behenyl acrylate, 0.5 wt % dodecanthiol and 0.5 wt % dimethyl-2,2′-azobis(2-methylpropionate) were added to this solution. The solution was heated to 70° C. and stirred for 20 h.

### Example 2

Dispersion of Polyisobutylene MW 1,000 g/mol (Laboratory Batch Process)

A 700 mL glass reactor is charged with 250 g polyol Lupranol® 2095 (trifunctional polyetherol with primary OH endgroups based on glycerol with MW 5000 by BASF SE), 50 g preformed stabiliser and 200 g polyisobutylene with molecular weight 1,000 g/mol (Glissopal® 1000 by BASF). The reaction mixture was heated to 240° C. and stirred at 600 rpm for 2 h. A white viscous solution was yielded. The viscosity of the product was 6630 mPas (1/50 1/s at 25° C.) and a particle diameter of D[3,2] 1.566 μm was determined. The product was phase stable for at least several weeks.

### Example 3

Dispersion of Polyisobutylene MW 1,000 g/mol (Large-Scale Melt Emulsification)

A dispersion of 40 wt % polyisobutylene (MW 1000 g/mol) in 50 wt % polyetherol GEP330NY by Gaoqiao Sinopec (trifunctional polyetherol with primary OH endgroups based on glycerol with MW 5000) was prepared by melt emulsification process. Preformed stabiliser (10 wt %) was added during the process. The extruder zones were heated to following temperatures: 25° C. (zone 1), 180° C. (zone 2-10) and the head of the extruder was heated to 180° C. The speed of the extruder was adjusted to 800 rpm and the material was fed into zone 2 with 60 kg/h. A rotor-stator was attached to the extruder head (4,000 rpm). A viscosity of 4175 mPas and mean particle size of 5.276 μm was determined for the phase-stable product and the product was stable for at least several weeks.

### Example 4

Dispersion of Polyisobutylene MW 2.300 g/mol (Laboratory Batch Process)

A 700 mL glass reactor is precharged with 50 g preformed stabiliser and 200 g polyisobutylene with molecular weight 2,300 g/mol (Glissopal® 2300 by BASF). The reaction mixture was heated to 240° C. and stirred at 600 rpm. 250 g polyol Lupranol® 2095 (trifunctional polyetherol with primary OH endgroups based on glycerol with MW 5000 by BASF SE) was slowly added to the reaction mixture followed by 1 h stirring at reaction temperature. A white viscous solution was yielded. The viscosity of the product was 654 mPas (1/50 1/s at 75° C.) and a particle diameter of D[3,2] 2.667 μm was determined. The product was phase stable for at least several weeks.

### Example 5

Dispersion of Polyisobutylene MW 2,300 g/mol (Large-Scale Melt Emulsification)

A dispersion of 40 wt % polyisobutylene (MW 2300 g/mol) in 50 wt % polyetherol GEP330NY by Gaoqiao Sinopec (trifunctional polyetherol with primary OH endgroups based on glycerol with MW 5000) was prepared by melt emulsification process. Preformed stabiliser (10 wt %) was added during the process. The extruder zones were heated to following temperatures: 25° C. (zone 1), 170° C. (zone 2-10) and the head of the extruder was heated to 170° C. The speed of the extruder was adjusted to 800 rpm and the material was fed into zone 2 with 60 kg/h. A rotor-stator was attached to the extruder head (8,000 rpm). A viscosity of 3049 mPas and mean particle size of 4.507 μm was determined for the phase-stable product and the product was stable for at least several weeks.

### Example 6

Dispersion of Polyisobutylene MW 20,000 g/mol (Laboratory Batch Process)

A 700 mL glass reactor is precharged with 50 g preformed stabiliser and 200 g polyisobutylene with molecular weight 20,000 g/mol (Oppanol B10 by BASF). The reaction mixture was heated to 240° C. and stirred at 600 rpm. 250 g polyol Lupranol® 2095 (trifunctional polyetherol with primary OH endgroups based on glycerol with MW 5000 by BASF SE) was slowly added to the reaction mixture followed by 1 h stirring at reaction temperature. A white dispersion was yielded.

The viscosity of the product was 10590 mPas (1/50 1/s at 25° C.) and a particle diameter of D[3,2] 2.284 μm was determined. The product was phase stable for at least several weeks.

### Example 7

Dispersion of Polypropylene MW 20,000 g/mol (Laboratory Batch Process)

A 700 mL glass reactor is charged with 160 g bifunctional polyetherol polyol Lupranol® 1100 (bifunctional polyetherol with secondary OH endgroups with MW 1000 by BASF SE), 80 g preformed stabiliser and 160 g polypropylene with molecular weight 20,000 g/mol by Sigma Aldrich. The reaction mixture was heated to 240° C. and stirred at 400 rpm for 1 h. A white viscous solution was yielded. The viscosity of the product was 6853 mPas (1/100 1/s at 75° C.) and a particle diameter of D[3,2] 2.643 μm was determined. The product was phase stable.

1-26. (canceled)

27. A stabiliser, comprising a reaction product of at least one macromer with at least one C₄₋₃₀-alkyl(meth)acrylate in at least one polyether polyol 1 in the presence of at least one free radical polymerisation catalyst and optionally at least one chain transfer agent,
the at least one macromer being at least one molecule which comprises in its structure at least one polymerisable double bond, able to copolymerise with a C₄₋₃₀-alkyl(meth)acrylate and which furthermore comprises in its structure at least one hydroxyl-terminated polyether chain,
wherein a weight ratio of the reaction product of the at least one macromer with the at least one C₄₋₃₀-alkyl(meth)acrylate to the at least one polyether polyol 1 is in a range of from 20:80 to 80:20, and
the stabiliser has a particle size DSO smaller than 0.5 μm as determined by static laser diffraction, using a Mastersizer 2000 (Malvern Instruments Ltd), of a sample comprising the stabiliser and diluted with isopropanol in order to obtain an optical concentration suitable for the static laser diffraction.

28. The stabiliser of claim 27, wherein the weight ratio of the reaction product of the at least one macromer with the at least one C₄₋₃₀-alkyl(meth)acrylate to the at least one polyether polyol 1 is in a range of from 50:50 to 70:30.

29. The stabiliser of claim 27, wherein an amount of the at least one C₄₋₃₀-alkyl(meth)acrylate is 5 to 50 wt %, based on a total amount of the stabiliser, which is 100 wt %.

30. The stabiliser of claim 27, wherein the at least one C₄₋₃₀-alkyl(meth)acrylate is employed together with acrylonitrile, styrene, or a mixture thereof.

31. The stabiliser of claim 27, wherein the reaction product of the at least one macromer with the at least one C₄₋₃₀-alkyl(meth)acrylate is free from polymerised acrylonitrile and styrene units.

32. The stabiliser of claim 27, wherein the at least one macromer is obtained by reacting at least one polyether polyol 2 with an organic compound comprising a polymerisable double bond able to copolymerise with a C₄₋₃₀-alkyl(meth)acrylate and a carboxyl, anhydride, isocyanate, epoxy or other functional group able to react with an active hydrogen-containing group,
wherein a molar ratio of polymerisable double bonds to hydroxyl groups of the polyether polyol 2 to be reacted is in a range of from 0.03 to 0.30.

33. The stabiliser of claim 32, wherein the organic compound comprising the polymerisable double bond able to copolymerise with the C₄₋₃₀-alkyl(meth)acrylate and the carboxyl, anhydride, isocyanate, epoxy or other functional group able to react with the active hydrogen-containing group is selected from the group consisting of isocyanate ethyl methyl acrylate (IEM), 1,1-dimethyl meta-isopropenyl benzyl isocyanate (TMI) and mixtures thereof.

34. The stabiliser of claim 32, wherein the at least one polyether polyol 1 and the at least one polyether polyol 2 are each independently a two- to eight-functional polyether polyol with a molecular weight (Mₙ) of from 500 to 30,000 g/mol.

35. The stabiliser of claim 34, wherein the at least one polyether polyol 1 and the at least one polyether polyol 2 are the same.

36. The stabiliser of claim 34, wherein the at least one polyether polyol 2 is a six-functional polyether polyol and the at least one polyether polyol 1 is a three-functional polyether polyol.

37. A process for preparing the stabiliser of claim 27, the process comprising reacting the at least one macromer with at least one C₄₋₃₀-alkyl(meth)acrylate in at least one polyether polyol 1 in the presence of a free radical polymerisation catalyst and optionally at least one chain transfer agent.

38. A process for preparing a dispersion of at least one polyolefin in at least one polyol 3, the process comprising a melt emulsification of the at least one polyolefin, the at least one polyol 3 and at least one stabiliser of claim 27.

39. The process of claim 38, wherein the at least one polyolefin is selected from the group consisting of a polyethylene, a polypropylene, a polybutylene, a polyisobutylene, a polybutadiene and mixtures thereof.

40. The process of claim 38, wherein the at least one polyol 3 comprises a two- to eight-functional polyol with a molecular weight (Mₙ) of from 500 to 30,000 g/mol and may be the same as the at least one polyether polyol 1.

41. The process of claim 38, wherein the at least one polyol 3 is selected from the group consisting of a polyetherol; a polyesterol; a polycarbonate polyol; a polyether amine; a hydroxyl-functionalised fatty acid derivative of a polyetherol, polyesterol, polycarbonate polyol or polyether amine; an alkoxylation product of a polyetherol, polyesterol, polycarbonate polyol or polyether amine; and mixtures thereof.

42. The process of claim 38, wherein the dispersion comprises 5 to 20 wt % of the at least one stabiliser and 10 to 60 wt % of the at least one polyolefin, based on a total amount of the dispersion, which is 100 wt %.

43. The process of claim 38, wherein the melt emulsification is performed in an extruder at a temperature in a range of from 140 to 240° C. or in a kneader at a temperature in a range of from 180 to 260° C.

44. A process for preparing a polyurethane, the process comprising:
preparing a dispersion of at least one polyolefin in at least one polyol 3, the dispersion comprising at least one stabiliser of claim 27,
the melt emulsification of the at least one polyolefin, the at least one polyol 3 and the least one stabiliser,
mixing the dispersion with a polyisocyanate and, if appropriate, at least one further compound having hydrogen atoms which are reactive towards an isocyanate, a chain extender and/or crosslinker, a catalyst, a blowing agent and a further additive, and
reacting the mixture to form the polyurethane.

45. The process of claim 44, wherein the polyurethane is a polyurethane foam and the mixture comprises a blowing agent.

46. The process of claim 44, wherein the polyurethane is a compact polyurethane material.
